(19) United States
(12) Patent Application Publication
(10) Pub. No.: US 2015/0081532 A1
(43) Pub. Date: Mar. 19, 2015

(54) VENUE WI-FI DIRECT SYSTEM

(71) Applicants: Yolanda Lewis, San Jose, CA (US); Edmond DeFrank, Northridge, CA (US); Everett Glenn, Long Beach, CA (US); Nicolas DeFrank, Northridge, CA (US); Antonio DeFrank, Northridge, CA (US); Allen Mark Jones, Imperial Beach, CA (US)

(72) Inventors: Yolanda Lewis, San Jose, CA (US); Edmond DeFrank, Northridge, CA (US); Everett Glenn, Long Beach, CA (US); Nicolas DeFrank, Northridge, CA (US); Antonio DeFrank, Northridge, CA (US); Allen Mark Jones, Imperial Beach, CA (US)

(21) Appl. No.: 14/485,789

(22) Filed: Sep. 14, 2014

Related U.S. Application Data
(60) Provisional application No. 61/879,147, filed on Sep. 18, 2013.

(51) Int. Cl. G06Q 30/02; G06Q 90/00; H04W 4/00; H04W 4/02; G06Q 50/00; G06Q 20/32; H04W 4/22

(52) U.S. Cl. CPC G06Q 30/0281; G06Q 20/322; G06Q 90/20; H04W 4/22; H04W 4/02; G06Q 50/00; H04W 4/003
USPC 705/39; 705/346; 705/323

(57) ABSTRACT

The embodiments disclose a method including providing venue specific localized WI-FI user mobile venue related services in a covered venue area, installing in a densely populated covered venue area technology capabilities capable of handling a number of users in real time and a number of services in real-time, and using localized WI-FI user mobile applications to provide venue related services.

### CROSS-REFERENCE TO RELATED APPLICATIONS

This application is based on U.S. Provisional Patent Application Ser. No. 61/879,147 filed Sep. 18, 2013, entitled “VENUE WI-FI DIRECT SYSTEM”, by First Named Inventor Yolanda Lewis, et al.

### BACKGROUND

Local WI-FI service is established small venues for example hotels which may only have a few hundred rooms. This limited user service lack bandwidth to serve a greater number of users and provide lack luster services.

### BRIEF DESCRIPTION OF THE DRAWINGS

FIG. 1 shows a block diagram of an overview of a venue WI-FI direct system of one embodiment of the present invention.

FIG. 2 shows a block diagram of an overview flow chart of a venue WI-FI direct system of one embodiment of the present invention.

FIG. 3 shows for illustrative purposes only an example of venue WI-FI direct system services of one embodiment of the present invention.

FIG. 4 shows for illustrative purposes only an example of venue WI-FI direct mobile orders app of one embodiment of the present invention.

FIG. 5A shows for illustrative purposes only an example of sports venue of one embodiment of the present invention.

FIG. 5B shows for illustrative purposes only an example venue WI-FI direct scanner app of one embodiment of the present invention.

FIG. 6 shows for illustrative purposes only an example of venue WI-FI direct mobile alerts of one embodiment of the present invention.

FIG. 7 shows for illustrative purposes only an example of venue WI-FI direct people tracking app of one embodiment of the present invention.

FIG. 8 shows for illustrative purposes only an example of venue WI-FI direct fantasy sports app of one embodiment of the present invention.

FIG. 9 shows for illustrative purposes only an example of venue WI-FI direct video, mms, picture-and-text mobile advertising of one embodiment of the present invention.

FIG. 10A shows for illustrative purposes only an example of signal coverage using HDWIFI of one embodiment of the present invention.

FIG. 10B shows for illustrative purposes only an example of WI-FI communication layers using HDWIFI of one embodiment of the present invention.

FIG. 10C shows for illustrative purposes only an example of a HDWIFI router of one embodiment of the present invention.

FIG. 11A shows for illustrative purposes only an example of a HD8000 Series component of one embodiment of the present invention.

FIG. 11B shows for illustrative purposes only an example of a HD8000 Series component views of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a venue WI-FI direct system is described for illustrative purposes and the underlying system can apply to any number and multiple types venues with dense populations. In one embodiment of the present invention, the venue WI-FI direct system can be configured using at least one user mobile device application. The venue WI-FI direct system can be configured to include user scanned purchases and can be configured to include mobile alerts using the present invention.

The power and control of the search process is in the hands of each individual unique mobile device user. Enabling technology that gives mobile device users in the covered area time back by becoming a personal smart concierge. User have the tools to connect anytime anyplace accessing relevant information based on where they are real-time. Provides a direct customer feedback component of one embodiment.

QR-Code orders and purchases allow mobile device users to enjoy quick turnaround and faster service at sporting events and concerts at large arenas. Users simply scan the QR Code on their seat, which brings up a menu of all available vendors and their food selections in the arena. Orders are placed on the mobile device and payment is processed in a cashless system. Order is delivered to the users location. Each QR-Code carries the location of the seat information in the covered area of one embodiment.

### Technology Capabilities:

Multi-radio units interchangeable/upgradeable. Spectrum settings adjustments based on devices in the environment. Multi-band capabilities as standards change to enable greater throughput. Processing capabilities leveraging multiple data pipes sending information to servers. Process of multiple levels of services simultaneously on parallel platforms. Capable of handling the number of users in real time and the number of services in real-time of one embodiment.

Ability to create different channel on a different frequency to manage each of the different 802.11 standards, which can be changed in each individual sector in the unit controlled by software, enabling system reconfiguration manually or automatically to match the devices connecting to the network. Identify devices on the network—we can add the ability to segment different devices onto different radios to improve throughput. Placing devices on like radios based on technical make up. Assigning priorities for network access based on specific device types of one embodiment.

Utilization of parallel or serial command and control computer and communications software platform architecture to deliver real-time interoperability among the many disparate “equipment systems” found throughout a large complex operational in a serial or parallel command and control computer architecture of one embodiment.

### Real-Time Systems Integration Platform:

The PECOS/HIPPOS software provides comprehensive, real-time, systems integration for any and all equipment devices simultaneously, independent of manufacture. PECOS is a generic computer operating environment for equipment integration and HIPPOS is a software application dedicated to the management of communications technologies with PECOS embedded. We deliver the only control software platform of providing real-time (sub-second) interoperability among the many different, incompatible, “equipment systems” in large complex environments.

### International Standard for Equipment Systems Integration:

PECOS is a modular, distributed, personal computer based, and equipment control system. It fully integrates all functions on touch-graphic control consoles. Systems studies and construction for PECOS are widespread within DOE and DOD and are the standard for nuclear weapon processes nationally. The modular, distributed and adaptable nature of PECOS gives users a total solution for their equipment control needs.

### Advantages

Permits an unlimited number of simultaneously functional graphic control consoles servicing all devices.
Accommodates specifications for any equipment subsystem, concentrating on functionality without regard for vendor proprietary constraints.
Permits connections for the equipment transparently to the system, changes to the configuration, enlargement of the system, connections of one entity to another, and the addition of competing product while leaving the electronic control platform unchanged and without taking the system off-line.
Graphic consoles control communications, energy management, emergency response, process controllers, video, security, fire and life safety, access controls, lighting, HVAC, refrigeration, asset tracking, robotics, point of sale, elevators, signs, sensor arrays, radar etc.
   International standard for equipment systems integration. The structure inherently supports redundant computers and communications—no comparable feature exists in serial architectures.

### Hyper Imbedded Parallel Processing Operating System (HIPPOS):

HIPPOS fundamentally reverse the conventional process of building integrated equipment systems. We assemble a vendor-independent integrated control-operating platform eliminating the need for vendors to assemble an integrated system using their limited product line with custom software. We deliver the best-in-class equipment selected from all available products and sources connecting them with our High Density Wireless Fidelity (HD WIFI) communications. Unprecedented for its cost effectiveness.

### HDWIFI Technologies:

High Density (HD) WIFI (HDWIFI) is Carrier Grade equipment and was designed and developed, with content delivery in mind. In today's communications ecosystem, BYOD (Bring Your Own Device) has transformed how we all interact with media with our own mobile devices. We have come to expect always on connectivity no matter where we are, and the number one driver is video and related feature rich applications. HDWIFI delivers that content more effectively than others and maintains better connectivity. We provide greater capacity, faster data speeds, and more security to users. All at a much lower cost than a similar deployment with competing hardware. Where others may need almost a thousand access points we can provided the same coverage with a couple hundred of our core units. This key factor epitomizes the strength and resilience of our system, the ROI is faster for our customers, because the cost of entry is significantly lower. HDWIFI is also upgradeable to future standards as they evolve, providing an almost future proof solution to the location owner. Our approach to wireless communications, also expands upon the availability and direction of the content being delivered. Whether it be a mobile application allowing for the purchasing of products within a stadium, or any other application. Our smart system which we call HIPPOS, developed and licensed to us by the original team of programmers with over a $1 Billion investment by the DOD. Enhances, and manages the traffic flow, access, security and speed. Ensuring the experience expected by the customers, and required by the location owners are met with no loss in quality, and with no delay in delivery. Which translates to more sales within and around the locations. Bullet Points to think about when looking at our HDWIFI solution, and its advantages!
Wireless Intrusion Protection System (WIPS)
   DOD derived
   Anti-Hacking and Anti DOS system
   Real-Time Intrusion Protection
   Offensive Protection option, not just passive available as an option
Installed costs normally 40-50% lower than major competitors
Long signal ranges, capable of covering stadiums and large buildings to cities
Geo-location and geo-fencing controls
Performance enhancing software for interactive games, video and other rich media content
Universal coverage—‘In Room’, Public Areas and Perimeter of Property
Mesh linkage capability for broad city-wide coverage areas
Multipolar Antenna Design
Marketing capabilities based on data collection and Custom Portals
Flexible Advertising capacity on Wi-Fi entry portals
Other Value-added services easily embedded by HDWIFI
   Mini Bar Monitoring
   iCart—Maids Cart Tracking
   Employee Tracking
   iPhone/Android Push to Talk Application
   Interactive TV/VOD (Video On Demand)
   HVAC Controls
   Custom iPhone/Android Applications
   And more . . . .

100 or 100,000 users, HDWIFI provides the right solution to ensure continuous connectivity and full network access. We deliver technology unmatched by any other vendor and are prepared to demonstrate this fact in any head to head comparison and or demonstration against any competitor products.

HDWIFI “Basic System” can support up to 140 mix mode active users per radio link now, and over 2.5× that for non-active users using the same formulas.
HDWIFI Does not rely on old processor/hardware designs to limit the full extent of the available bandwidth.
We exclusively use MULTIPLE multicore processors in all our designs, why limit the network.
We design our radio systems from the back forward to ensure the user gets the maximum available bandwidth speed.
No Slow bus architectures or network interfaces.
Our Parallel HIPPOS controllers ensure data is offloaded fast and efficiently. Less time on network=more users and greater overall capacity.
Our Multipolar MultiFeed Antenna Technology ensures each sector maintains maximum signal quality to the users ensuring a faster offload and better coverage.
Our system provides for multiple service levels and coverage's even within the same area True Multi Layer WIFI.

More Wi-Fi Coverage and Capacity using HDWIFI. Basic Wi-Fi Provides For Little Capacity & Coverage on ONE Maybe TWO Frequencies Concurrently. Our HD WIFI Provides For Greater Capacity & Coverage on MORE Frequencies Concurrently.

### HD (High Density) WIFI:

True anywhere wireless connectivity whether speaking on your mobile phone, surfing or just checking your email has become a much more prevalent driver now, than it was less than 10 years ago when voice was still the only major solution provided by mobile carriers, and WIFI was still in its infancy and evolving. BYOD, or Bring Your Own Device is common place today. Especially in the workplace where Smartphones, Tablets, Ultrabooks and Laptops alike all require some form of data connection and wireless signal. In public venues like Stadiums, Arenas, Hotels and Convention Centers the number of users demanding such a signal is overwhelming the network operators, planners and designers of such systems. To understand HDWIFI though, we need to delve into a little bit of wireless history.

Now during the early days of wireless development Wi-Fi in some of its incarnations was adopted as a cheap means to provide municipal service. Between 2003, and 2007 major metropolitan areas attempted to deploy large scale Wi-Fi services to its citizens. Some successfully, and some not so successfully. Even the successful ventures though failed in one form or another due to technical issues which fell back on two things.
One, the consumer was never educated on the reality of the signal being delivered. Consumers are used to picking up a mobile device, and placing a call, or having a solid laptop link to a very close hotel, or home Wi-Fi system. They always expected to receive a signal.
Second, the hardware vendors, system integrators and buyers alike where unfamiliar with the realities of delivering a signal, proper system planning or grossly overrated their own systems performance and user capacities.

Fast forward to present day, and number one is still the most common. Today's consumers don't really understand the reality of RF (Radio Frequency) signals or what they know as WIFI, LTE, WiMAX or even Cellular standards such as GSM, and TDMA. The knowledge of the average consumer relates to one thing which the mobile carriers over the years have in one fashion or another embedded in their minds through advertising and other media.

If you have bars you have signal, the more bars the stronger the signal. Now that's an easy way to deliver an understandable translation of a picture which has a very technical underpinning layer of complexity. The consumer see's bars so he expects communications, and instant wireless gratification. The reality is much more than that though, because the bars are also the most deceptive, and the consumer doesn't realize the true meaning behind the bars. Signal bars are seen on all mobile wireless devices, they are used to inform the user of which networks are available, and the strength of the signal. That aspect they understand, what they don't understand is that the signal strength does not relate to their ability to communicate both ways.

A signal strength indicator no matter what device it is displayed on is only a measure of the received signal strength, it does not measure the consumer's ability to communicate back to the signals point of origin. This is more prevalent in WiMAX, and Wi-Fi, than in GSM/CDMA and LTE. Imagine a cellular signal being 6 m in size, vs. Wi-Fi which is a 1 m or less in size for illustration purposes. If we were to adjust the signal bar indicator to be a true measure of connectivity in todays deployed networks everyone would be walking around with one bar, maybe two or none depending on where they were standing hence the drop call effect or no data.

This most simplistic of issues was one of the major contributors to the massive failure of municipal Wi-Fi deployments in the early 2000's and other large scale deployments worldwide. It still is here today though. Consumers would always say, and still say, “My device can see the signal, I have full bars but I am not getting my service . . . something must be wrong with the service”. Yes, and no is the answer. Yes, because the networks where not planned on taking the multitude of designs of consumer devices available in mind when planning the signal coverage. No, because the consumer doesn't realize that the Wi-Fi radio in their mobile device is designed to work at distances on average of 150 ft. LOS (Line of Sight) with no interference from other users or devices, or obstacles of any sort; a proverbial “White Room”. They assume that because they have bars they have connectivity, and that is not always correct.

GSM/CDMA, and LTE does not suffer completely from the same problem. The answer is frequency, the lower the frequency the greater the coverage, longer the distance and greater the signal penetration. With the value add of less susceptible it is to interference, because it operates in licensed bands not shared with microwave ovens, wireless home phones, other carriers, users, etc. Wi-Fi operates in an unlicensed band which is shared and not regulated as to ownership or use. But Wi-Fi is inexpensive to install into all mobile devices, and as such has become the defacto standard for secondary or even primary data communications on all mobile devices used today.

System planning and capacity was the next major issue. Many worldwide Wi-Fi deployments where done with hardware, radios and systems intended only for home use where the number of user at that time would not exceed a predetermined amount and bandwidth was limited. The amount of users could vary, between 1 to 10 active users per radio at 512 Kbps to 768 Kbps. Networks became over saturated even with the limited scale of Wi-Fi enabled devices available at that time. Today with the high demand for media, and content all in real-time these active users are bring networks down with the amount of traffic being generated. Scale these up to locations where you may have 1,000's of users, and that further curtails performance.

HDWIFI solves this and other Wi-Fi deployment problems. Our HDWIFI is designed from the back forward ensuring that the total available capacity is consistent from the backend of the systems and ultimately to the user. Content critical deployments will not be hampered by slow data streams. Or be overwhelmed by too many users. Our nodes are designed to create multiple RF layers over an area, each layer independently fed by patent pending multipolar MIMO antennas which can also be adjusted to tailor the coverage's within each layer. No other vendor's product has this capability. Imagine having an array that can be custom tailored for each area or zone.

This ensures better coverage and reliability beyond what is capable with traditional beam forming technologies. From large stadiums comprising of bleachers and stands to press boxes or suites, coverage can be independent or uniform designed to the specific need or requirement. Each of these layers can operate within the same geographical area, imagine one layer being used to service sports wagering, another live video feeds from the field, and the third taking orders for drinks and food all directed to the same devices and selectable by the user. These new patent pending multiple radio MESH Nodes are designed by the original inventors of multiple radio MESH, and the manufacturer and designer of multipolarized antennas and have over 30 years of experience with 10,000's of units sold. This next generation High Density Wi-Fi system meets the demand of todays over saturated Wi-Fi networks, and is 100% upgradeable to new technologies as the evolve, technologies like 802.11ac.

Our Antenna coverage and penetration is unmatched in the industry. Our WiFi-Plus antenna developers have over 40 years of combined antenna design experience in supplying antenna products for commercial vendors of other radio devices. From onboard ships at sea, airlines, mines, hospitals, hotels, casinos, and much more. These multipolarized antennas have always gone the extra mile, and distance in penetrating obstacles and materials alike.

HDWIFI uses powerful embedded multicore processor technology capable of supporting the needs of thousands of users per node and tens of thousands when more than one is deployed in conjunction with our HIPPOS (Hyper Imbedded Parallel Processing Operating Systems) wireless controller. Capable of processing many millions of transactions per second these Hyper nodes originally developed for the US DOD (Department of Defense) with over 25 years of development can handle millions of data points more efficiently than any other controller based wireless system with security that is unmatched in the industry. Each node can contain up to 8 radios, and can be stacked up to 24 radios. With a capacity of close to 2,400 associated users depending on customer configuration on a basic node, and more with others.

Lastly our nodes are each capable of being equipped with a proprietary WIPS (Wireless Intrusion Protection System) that not only monitors for rogue networks, but also for the first time in the industry can act proactively and target the individual wireless intruders offensively and not just in a passive manner to ensure the wireless networks performance is not affected.

Thus eliminating the time consuming requirement to check every wireless device entering a stadium for example for potential problems. HDWIFI is not just new technology, it is a Revolution in wireless content delivery and security capable of altering the landscape as we know it today with true ubiquitous coverage, performance and flexibility.

HDWIFI Solutions and its Advantages.
Wireless Intrusion Protection System (WIPS)
   DOD derived
   Anti-Hacking and Anti DOS system
   Real-Time Intrusion Protection
   Offensive Protection option, not just passive available as an option
Installed costs normally 40-50% lower than major competitors.
Signal range over 1+ miles dependent on antenna selection.
Geo-location and geo-fencing controls for tracking.
Built-in optional GPS.
Performance enhancing software for your applications.
Universal coverage—‘In Room’, Public Areas, Perimeter of Property, City Wide.
Enhanced Mesh linkage capability for broad city-wide coverage areas.
Multipolar Antenna Design.
Marketing capabilities based on data collection and Custom Portals.
Flexible Advertising capacity on entry portals.
Value-added services easily embedded.
Enhanced signal coverage in heavy construction zones, and underground.

### Key Features:

Unmatched indoor and outdoor capacity. Revolutionary advance design from the original inventors of multiple radio wireless MESH with multiple concurrent 802.11n radios. A robust, scalable wireless solution based on the most sophisticated operating system and hardware choices available in the industry. Capable of delivering the first, and last mile Quad-Play. Our patented system creates a multi-layered communications cloud over the desired coverage area.
Rugged Carrier Class Design.
4 & 8 Radio (300 Mbps 2×2:2 MIMO) SmallCell.
4 Radio (450 Mbps 3×3:3 MIMO) operation.
High Performance UltraWideband Adaptable Antenna Technology.
8.2.11n 2.4/5 GHz operation, with other frequency options available including 700 MHz, 3.4-3.8 GHz.
GSM/LTE/WiMAX Capable.

HD8000 Series Multi-band 802.11n Wi-Fi node with small cell integration. Industry first high density 2.4/5 GHz 802.11n base station with remote adaptable antenna technology and HIPPOS parallel processing architecture built-in at the edge where it counts. The high density HD8000 series is the first multi-radio/multi-band 802.11, indoor and outdoor small cell (access point) to come with adaptable antenna technology which enables unlimited customization to your environment. This enables greater coverage, longer ranges, and better signal penetration. Designed and built by the original creators of multiple radio wireless MESH and multi-polarized antennas.

With embedded HIPPOS (Hyper Impedded Parallel Processing operating system). Independently developed for Department of Defense (DOD) and Department of Energy (DOE) applications, the HD series is the optimal solution for service providers to quickly and efficiently expand broadband services, offload data traffic from existing congested wireless networks, deploy multimedia hot spots or offer wireless broadband services where others cannot. HIPPOS technology also provides for a state of the art intrusion protection system, matched only by its defense counterparts. In over 25 years of deployments nationwide, no HIPPOS based system has ever been compromised.

Our high density solution is based on a patented multi-layered and multi-band wireless radio frequency (RF) architecture. Enhanced with the HIPPOs, multi-core architecture our units are designed to handle the traffic at the edge, and then further manage the process down stream throughout the rest of the network architecture. High density reliability capable of handling over 2000 associated users per core smartcell node. With up to 7.2 Gbps of total available Wi-Fi bandwidth per 802.11n small cell, and 9.2 Gbps total capacity per HIPPOS wireless controller. More than capable of providing unmatched quality of service in todays BYOD mixed mode environments. Our coverage manager interface allows for complete customization of the units working parameters and operation.

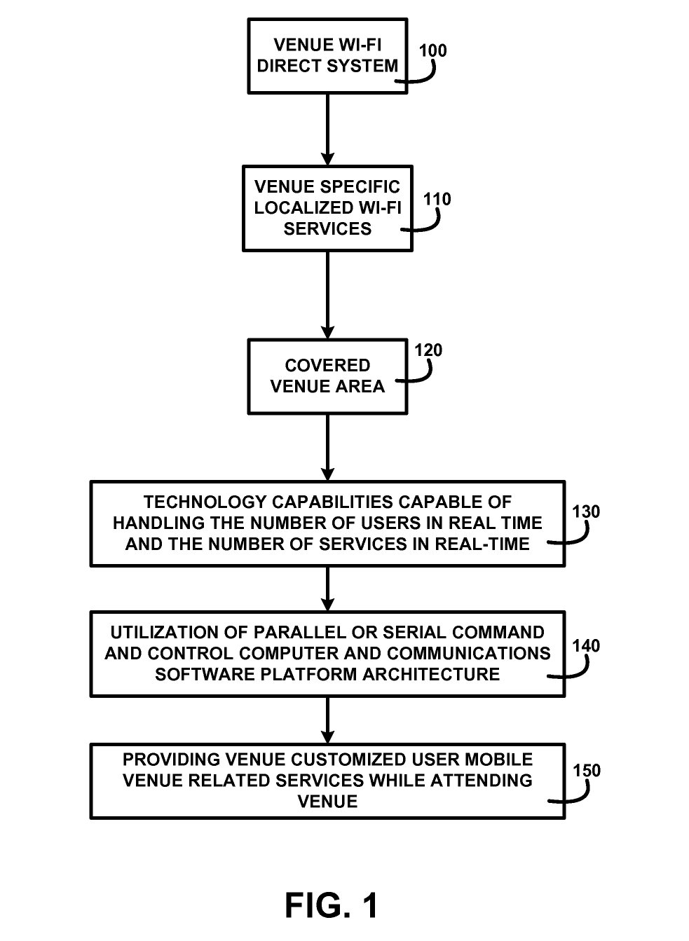

FIG. 1 shows a block diagram of an overview of a venue WI-FI direct system of one embodiment of the present invention. FIG. 1 shows a venue WI-FI direct system 100 configured to provide venue specific localized WI-FI services 110. The venue WI-FI direct system 100 is customized to serve a covered venue area 120. Technology capabilities capable of handling the number of users in real time and the number of services in real-time 130. This is in part by utilization of parallel or serial command and control computer and communications software platform architecture 140. Venue specific localized WI-FI services 110 include providing venue customized user mobile venue related services while attending venue 150 of one embodiment.

### DETAILED DESCRIPTION

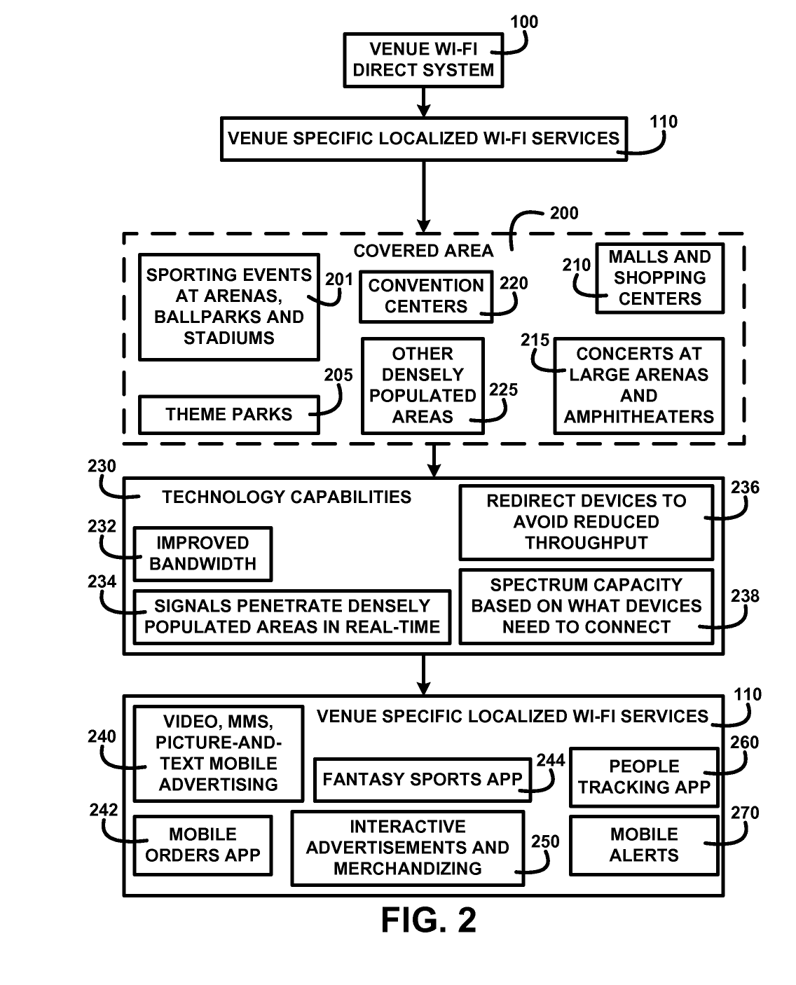

FIG. 2 shows a block diagram of an overview flow chart of a venue WI-FI direct system of one embodiment of the present invention. FIG. 2 shows the venue WI-FI direct system 100 which provides venue specific localized WI-FI services 110. The venue WI-FI direct system 100 can be customized to the services desired in a specific venue. The venue specific localized WI-FI services 110 would be available in at least a venue covered area 200. The covered area 200 can include sporting events at arenas, ballparks and stadiums 201, theme parks 205, malls and shopping centers 210, concerts at large arenas and amphitheaters 215, convention centers 220, and other densely populated areas 225 including public tourist attractions and parks of one embodiment.

The venue WI-FI direct system 100 can be expanded to theme parks and anywhere where's there's mass congregation and a desire/need for free wifi. For theme parks, it can be used to for fast passes, determine line waiting times, tickets, food ordering in advance, shows, etc. Also, it can be used for city areas, like a downtown area or during a farmer's market. It can be used to order food, buy souvenirs, watch videos, advertisements, track your location to find friends, locate shops or stands. It can be used during a concert or event. Users can get information about the performer, watch videos, record videos, share, etc. It can be used in Vegas to get show information or live sneak peaks at shows, events, inside casinos, live cams, traffic, etc. It can be used at large stores, like Costco or Frys to help the customer find products, look at product video reviews, etc of one embodiment.

For example, at a baseball park the user can place an order for popcorn. The user enters their seat number and how many bags of popcorn. This order is received by the WIFI system and relayed to the popcorn vendor closest to the seat. The vendor arrives at the seat and delivers the number of bags ordered, the user scans a bar code printed on the popcorn bag for each bag. The transaction is recorded and charged to the user credit card account. The vendor does not have to handle cash, the number of orders is automatically tabulated and the user has been able to make the purchase without cash. The number of orders automatically tabulated and remaining bags of popcorn for each vendor is calculated and the popcorn preparation stall know how much additional popcorn to start popping and bagging to replenish the various vendors. The cashless transactions are reported during and after the event. These WIFI transactions data is used to analyze which seating sections are buying the most popcorn and during which innings to enable management to deploy the vendors in the most active sections and order popcorn products including bar coded bags in numbers to anticipate sales in the upcoming events. The user benefits since these are cashless purchases they do not have to worry about running out of cash or finding an ATM to get more cash. Additionally they do not have to shut out to get the attention of the vendor and likewise the vendor does not have to walk up and down rows of stairs in hopes of getting a sale of one embodiment.

Coverage in the covered area 200 is configured to include technology capabilities 230 to service very large populations attending the venue. The technology capabilities 230 include improved bandwidth 232, signals penetrate densely populated areas in real-time 234, redirect devices to avoid reduced throughput 236, and spectrum capacity based on what devices need to connect 238 of one embodiment.

Customization in a specific venue include the venue specific localized WI-FI services 110. The venue specific localized WI-FI services 110 include video, Multimedia Messaging Service (MMS), picture-and-text mobile advertising 240, mobile orders app 242, fantasy sports app 244, interactive advertisements and merchandizing 250, people tracking app 260, and mobile alerts 270 of one embodiment.

### Restaurants:

The ability to allow customers to place orders on mobile devices and the ability to reach our staff if support is needed. I can order drink refills when my soda runs out, I can ask for ketchup if my table has none and I can request my check/bill and pay with my mobile and have the receipt uploaded for tax purposes without interacting with a person or waiting for the person to provide services.

### Business Establishments:

Self service model where customers are able to order what they want on the mobile and the staff/team pulls merchandise from the warehouse and delivers to the customer. Retail outlets—For example I went to Macys and they had a sale my sister and I had at least 5 pairs of shoes that we wanted to purchase we had to wait for all the other customers to get their shoes to get the ones we were going to purchase. The store was so crowded it too about an hour waiting and then we had to wait in line. We could have paid and ordered in a single transaction.

### Airlines:

Via WI-FI I am able to send requests to the airline attendants for drinks, food, blankets, in case of emergency and receive alerts when the restrooms are available so that I don't have to stand illegally at the door at the front of the cabin. Also, from the comfort of your seat, the capability to book airline tickets, local sporting and entertainment event tickets to where traveling, car rentals, hotels, tour packages, products, local souvenirs, duty free goods, local foods and spirits, etc. Also, service will collect all demographic information, including email and credit card information, but service is free. Airline mileage information can be looked up and logged into. Free coupons for local restaurants, tours, souvenir shops, etc. App to upload all of your vacation photos to Facebook, Twitter, etc. Maps to plan out your trip. VOIP for business travelers so they can make business phone calls while flying. Text app so people can text and instant message while flying.

### Convention Centers:

Maps to each Tradeshow/Conference vendor booth with links to data on what they are selling and the ability to receive walking directions—maps and directions to restrooms, information on how long lines are, data on restrooms that are out of service and information on shows/workshops and other events happening based on the current/upcoming times.

### Options:

Permits an unlimited number of simultaneously functional graphic control consoles servicing all devices.
Accommodates specifications for any equipment subsystem, concentrating on functionality without regard for vendor-proprietary constraints or concern about compatibility.
Permits connections for the equipment transparently to the system, changes to the configuration, enlargement of the system, connections of one entity to another, and the addition of competing product while leaving the electronic control platform unchanged—and without taking the system off-line.
Adapts to a particular site simply by designing the operators' console graphics.
Parallel architecture
Sufficient for scalability and response speed
Linear resources growth with linear expansion of devices of one embodiment.

Problems Solved:

### Need for Improved Bandwidth

Ability to have signals penetrate densely populated areas in real-time
Maximize spectrum capacity based on what devices need to connect
Redirect devices to avoid reduced throughput of one embodiment.

Convention Centers/Stadiums/Arenas

### Possible Applications

### Mobile Purchases

Mobile Payment system

### Mobile Ticketing

### Emergency Communications

Ability to deliver mobile services outside to tailgaters

### Ordering Food/Souvenirs

Statistical Data Collection of Mobile Users Activities, Movement and Actions to establish patterns for direct marketing
Advertising in stadium over WIFI
Push information such as how long lines are, food menus, traffic routes home
Streaming video
Instant replays
Communicate with concessions
Mobile gaming where users compete against each other in real-time
Ability to deliver a mobile loyalty program tracking sales
Ability to locate individuals in the covered area in similar groups/categories
Ability to search and connect with other mobile users that have open profiles matching search criteria of one embodiment.

### Venue WI-FI Direct System Services:

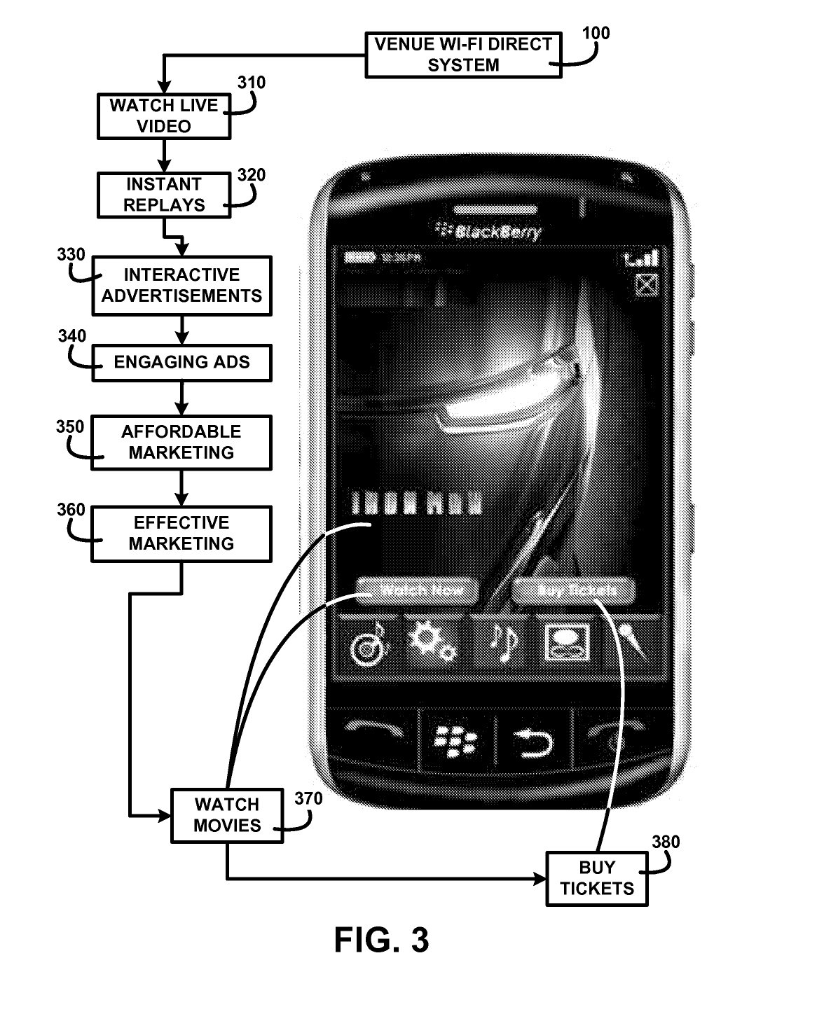

FIG. 3 shows for illustrative purposes only an example of venue WI-FI direct system services of one embodiment of the present invention. FIG. 3 shows the venue WI-FI direct system 100 that provides services to users at a venue including being able to watch live video 310 and access instant replays 320 at sporting events. The venue WI-FI direct system 100 provides a venue with services including interactive advertisements 330 where a user can make orders and purchase using mobile applications. The venue related services includes engaging ads 340 and provides affordable marketing 350 and effective marketing 360 of the population attending the venue. For example venue related services can include users being able to buy tickets 380 and watch movies 370 of one embodiment.

The WI-FI broadcast system is an excellent way to reach customers, congregations, students, staff, employees, members, friends, fans emergency personnel instantaneously. Important notifications related to Amber Alerts, safety issues, traffic jams, special announcements, event calendars, sales invitations, promo offers, product intros, discount deals can be transmitted to devices on the WI-FI network.

VIP service to guests. Now they are able to use these tools on the mobile platform as a means of securing loyal customers and revenue.

### Watch Live Video

### Instant Replays

Watch movies
Buy tickets
Interactive advertisements
Engaging ads
Affordable marketing
Effective marketing

### Venue WI-FI Direct Mobile Orders App:

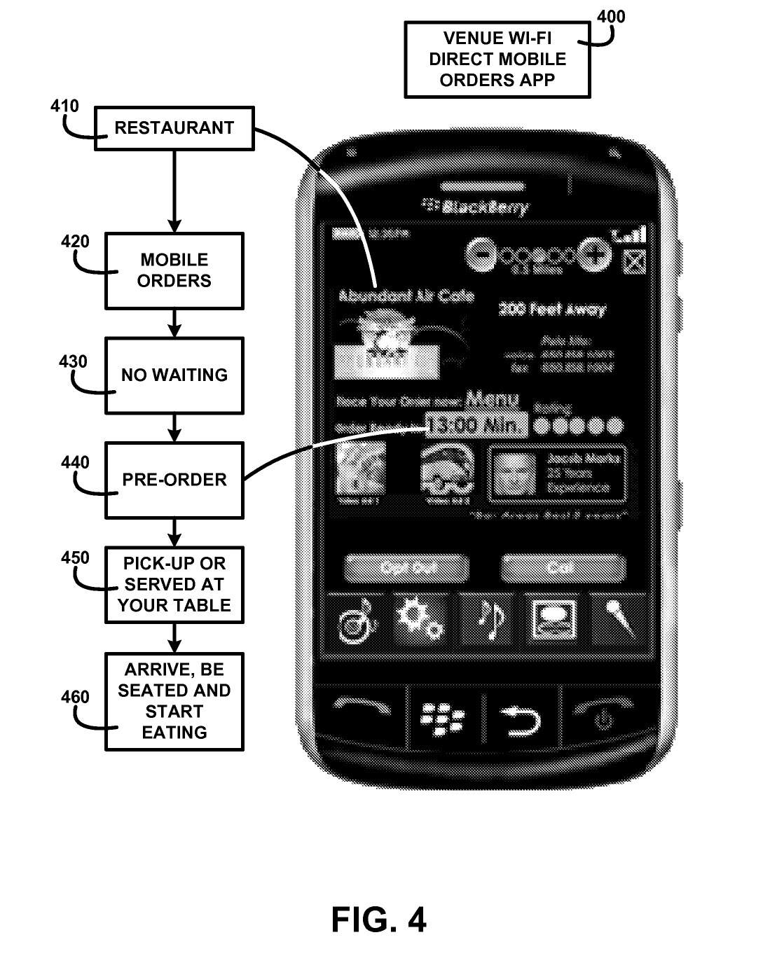

FIG. 4 shows for illustrative purposes only an example of venue WI-FI direct mobile orders app of one embodiment of the present invention. FIG. 4 shows a venue WI-FI direct mobile orders app 400 that can be used to place an order at a restaurant 410 while a user is in route to the restaurant 410. The restaurant 410 having installed the venue WI-FI direct system 100 of FIG. 1 accepts mobile orders 420. The user benefits from no waiting 430. A pre-order 440 can be made when the user is in range of the covered area. The order is ready upon the user arrival for pick-up or served at your table 450. The user can arrive, be seated and start eating 460 of one embodiment.

### Mobile Orders

No waiting
Pre-order
Pre-pay
Delivery to seat

### Sports Venue:

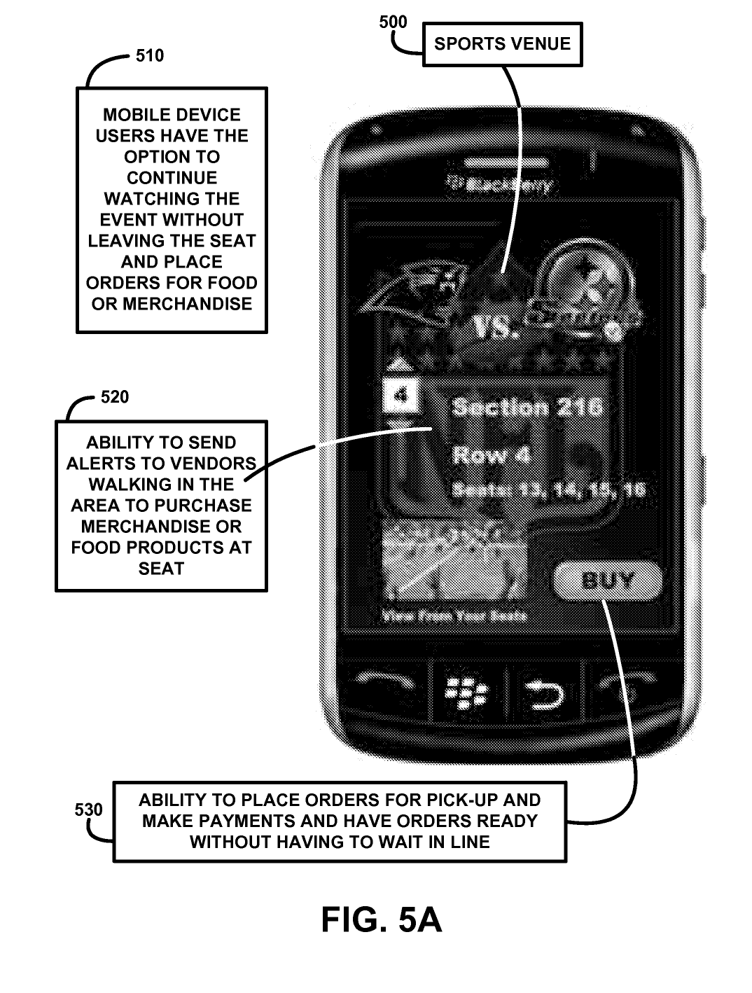

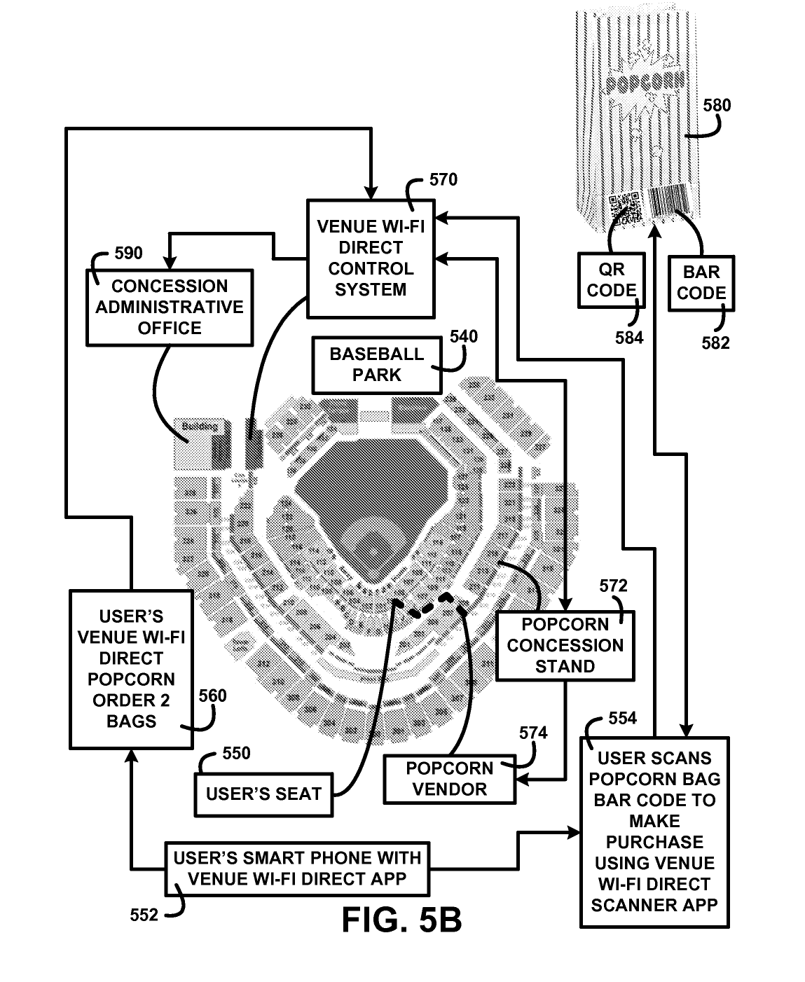

FIG. 5A shows for illustrative purposes only an example of a sports venue of one embodiment of the present invention. FIG. 5A shows a sports venue 500 where mobile device users have the option to continue watching the event without leaving the seat and place orders for food or merchandise 510. The user has the ability to send alerts to vendors walking in the area to purchase merchandise or food products at seat 520. Additionally the user has the ability to place orders for pick-up and make payments and have orders ready without having to wait in line 530 of one embodiment.

Mobile device users have the option to continue watching the event without leaving the seat and place orders for food or merchandise.
Ability to send alerts to vendors walking in the area to purchase merchandise or food products at seat.
Ability to place orders for pick-up and make payments and have orders ready without having to wait in line.

### Venue WI-FI Direct Scanner App:

FIG. 5B shows for illustrative purposes only an example venue WI-FI direct scanner app of one embodiment of the present invention. FIG. 5B shows the sports venue 500 of FIG. 5A for example a baseball park 540. The user is at a user's seat 550 and has a user's smart phone with venue WI-FI direct app 552. The user makes a user's venue WI-FI direct popcorn order 2 bags 560. The order is transmitted to a venue WI-FI direct control system 570 which relays the order to a popcorn concession stand 572. The popcorn concession stand 572 relays the order to a popcorn vendor 574 of one embodiment.

The popcorn vendor 574 goes to the user's seat 550 where the user scans popcorn bag bar code to make purchase using venue WI-FI direct scanner app 554. The venue has made their order of a popcorn bag 580 that includes an identifying bar code 582 and QR code 584. The record of the sale is transmitted to the concession administrative office 590 for accounting and reorder data. The order purchase is also sent to the popcorn concession stand 572 to enable the personnel to begin popping more popcorn of one embodiment.

### Venue WI-FI Direct Mobile Alerts:

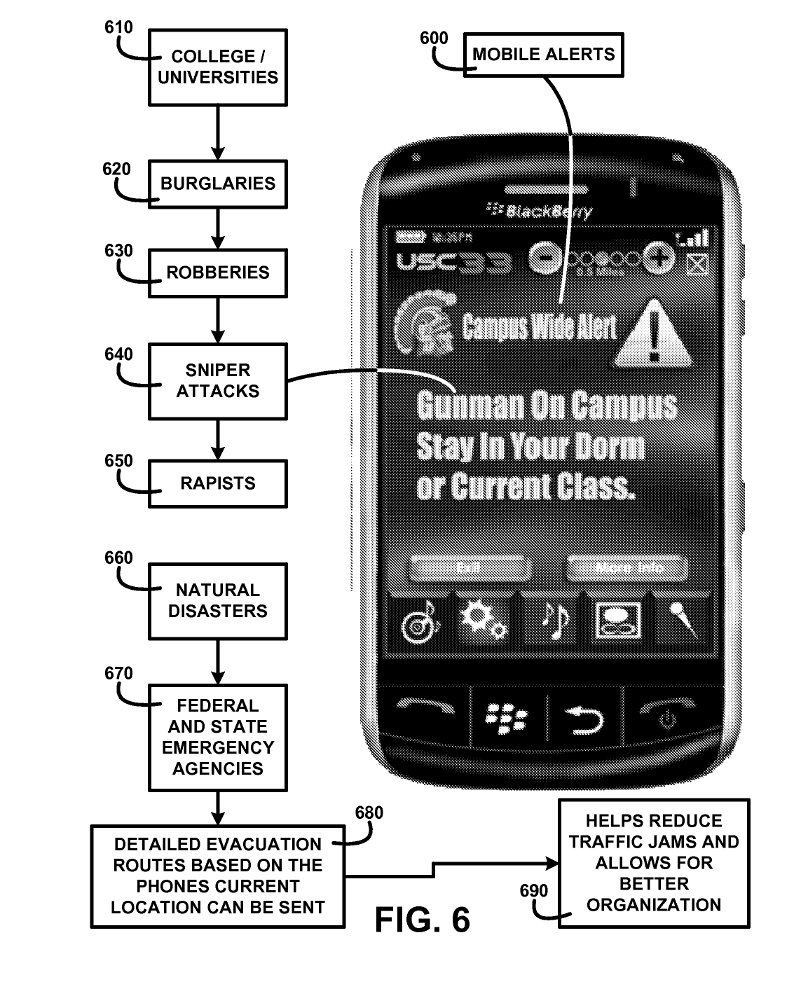

FIG. 6 shows for illustrative purposes only an example of venue WI-FI direct mobile alerts of one embodiment of the present invention. FIG. 6 shows mobile alerts 600 being issued on a university campus. The mobile alerts 600 are part of the venue desired services that can be customized for college/universities 610. Enrolling students are instructed to download the venue WI-FI direct mobile alerts app. The venue WI-FI direct system 100 of FIG. 1 provides the college/universities 610 with mobile alerts 600 to warn students about campus dangers including recent burglaries 620 and robberies 630 of one embodiment.

The mobile alerts 600 can provide students with immediate notice of for example sniper attacks 640 notifying and instructing students that there is a gunman on campus stay in your dorm or current class. The mobile alerts 600 can be used to alert students of rapists 650 and even display on their mobile devices a police artist sketch to enable students to alert authorities if they have seen anyone fitting the description of one embodiment.

The mobile alerts 600 can be used to assist in natural disasters 660. Federal and state emergency agencies 670 can help residents for example a detailed evacuation routes based on the phones current location can be sent 680. This also helps reduce traffic jams and allows for better organization 690 to cope with the natural disasters 660 of one embodiment.

Mobile Alerts

### College/Universities:

Keeps students alert to on campus emergencies. Campus police can send out an immediate blast to all students and faculty cell phones on campus with instructions.
Sniper Attacks
Robberies
Burglaries
Rapists

### Natural Disasters:

Federal and State emergency agencies can immediately release an alert to all mobile devices inside areas covered. In case evacuation is needed. Detailed evacuation routes based on the phones current location can be sent. This helps reduce traffic jams and allows for better organization.

### Venue WI-FI Direct People Tracking App:

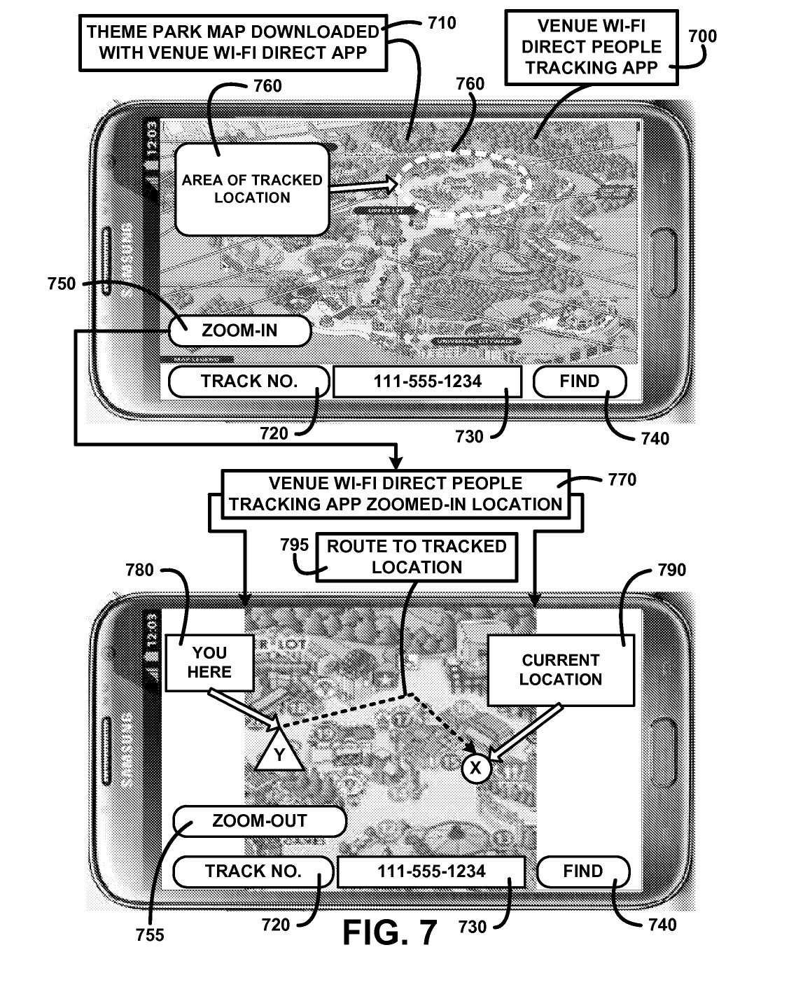

FIG. 7 shows for illustrative purposes only an example of venue WI-FI direct people tracking app of one embodiment of the present invention. FIG. 7 shows a venue WI-FI direct people tracking app 700 that can be used to locate people in a users group attending a densely populated venue for example a theme park. For example one parent and one child are engrossed in playing a carnival game. When they finish they look around and cannot see the other parent and other child. Before panicking the parent can consult a theme park map downloaded with venue WI-FI direct app 710 of one embodiment.

The parent user can enter a track no. 720 in this example the mobile device phone number 111-555-1234 730 of the missing parent. The parent user then taps a find 740 touch button. The venue WI-FI direct people tracking app 700 will then superimpose over the downloaded theme park map an area of tracked location 760. The parent user can then tap a zoom-in 750 touch button. Displayed is a venue WI-FI direct people tracking app zoomed-in location 770. It indicates the parent user location with a message you here 780 and shows the current location 790 of the missing parent near a restroom. The app shows a route to tracked location 795 to assist the family to be reunited quickly when a zoom-out 755 button clears the map display of one embodiment.

### People Tracking

Ability to search for individuals you are looking for on the mobile device in theme parks, stadiums, arenas and other high density areas over WIFI.

Mobile Search

Delivery of a proximity based platform encompassing features and functionality to connect real-time with people, places and or information relevant to where they are at anytime in the covered area.
Places search users are able to identify places with the specified proximity that match your search criteria.
A map is displayed for directions a phone number is displayed for the user to contact the location that they have just search for.
The ability to adjust proximity search results in relation to the mobile users current location eliminates unwanted clutter and irrelevant information not valuable to the individual user.
Ability to determine the range to search for information Proximity Search Ability to search for specific retail outlets

### Venue WI-FI Direct Fantasy Sports App:

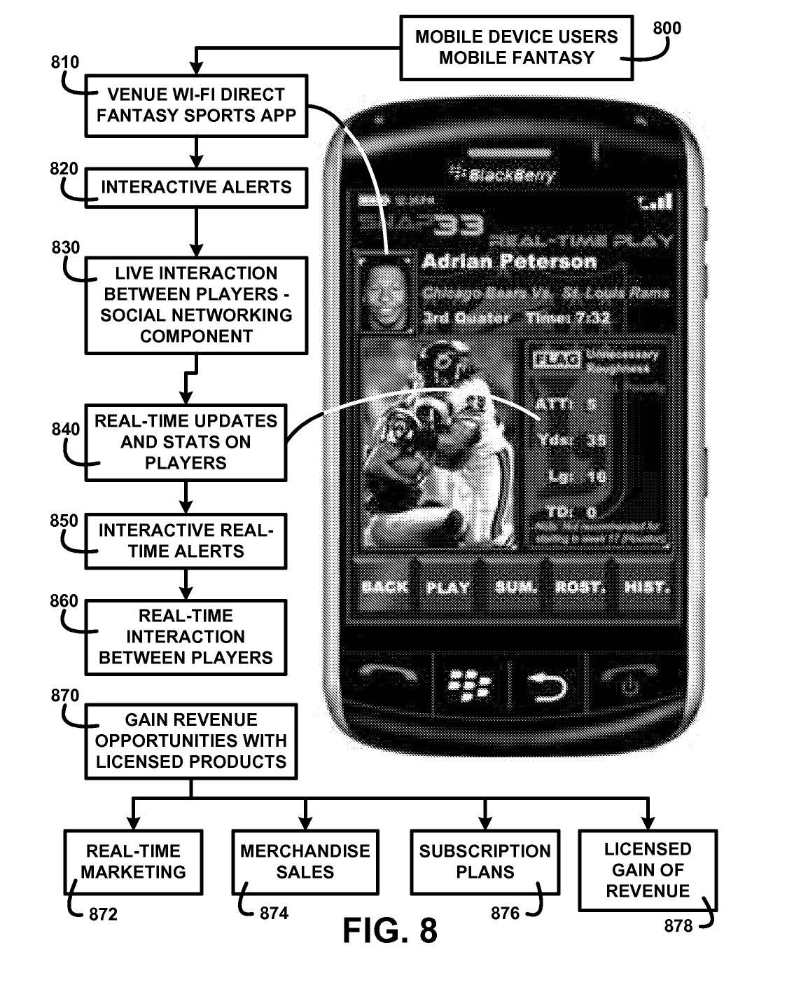

FIG. 8 shows for illustrative purposes only an example of venue WI-FI direct fantasy sports app of one embodiment of the present invention. FIG. 8 shows the venue WI-FI direct system 100 of FIG. 1 that includes a mobile device users mobile fantasy 800 venue WI-FI direct fantasy sports app 810. The venue WI-FI direct fantasy sports app 810 includes interactive alerts 820 and live interaction between players—social networking component 830. Real-time updates and stats on players 840 also include interactive real-time alerts 850. The venue WI-FI direct fantasy sports app 810 includes real-time interaction between players 860 of one embodiment.

The venue can gain revenue opportunities with licensed products 870, benefit from real-time marketing 872 and merchandise sales 874. The venue WI-FI direct fantasy sports app 810 can be customized to include subscription plans 876. Together with licensed gain of revenue 878 the venue can for example offer season ticket holder discounts and pre-release merchandise notices of one embodiment.

### Search-by-Keyword

Your ad can also be searched by keyword. Mobile phone users can type any word they wish to search. If this (key)word is found in the main text of your ad, your ad will be listed and displayed in the “search result”.

Example: If the mobile phone user searches for the word “STEAK” and the word “steak” can be found in the main body of your ad (maybe because you're a steak house or a restaurant that serves steak), then your ad will be listed in the search result. So, when writing your ad, consider using as many helpful keywords relevant to your business.

Ability to delete all non-relevant advertising that has not been dragged down and saved by the user in one command without having to delete each ad individually. Mobile devices are able to pull content that is relevant to a preprogrammed meta-tag(s). Upon completing the search relevant search results that fit inside the parameters will be displayed to the end user.

Mobile device users are empowered to use WI-FI network to find people in the same coverage area. The ability to define search radius to identify individuals in proximity.

Users are able to search for contacts in their personal networks, or broaden the search for new contacts to expand and grow their network. Mobile users can search for locations such as concession stands, restaurants, retail outlets, specific products and or services in the covered area. The unique search functionality of our methodology is that it will only display relevant results that are within proximity to the users current location.

The ability to connect with other users who have similar interests or our area based in search text. Are able to locate others who are there groups at the local area this can specify. Are able to search for other users will have open profiles match your search criteria.

Radius: Users are able to leverage graphical tools to increase or decrease search radius to increase or decrease the number of results delivered to the mobile device.
Cloak Mode: Mobile device users have the ability to hide their profiles from other users on the WIFI network or to make it available to specified individuals or groups.
VIP: Ability to block your profile or categorize groups of individuals who are able to see your profile who are also VIP level members. VIP access allows for your products/services to appear at the tope of the search results ahead of non-VIP accounts when users search.
Venue WI-FI Direct Video, mms, Picture-and-Text Mobile Advertising:

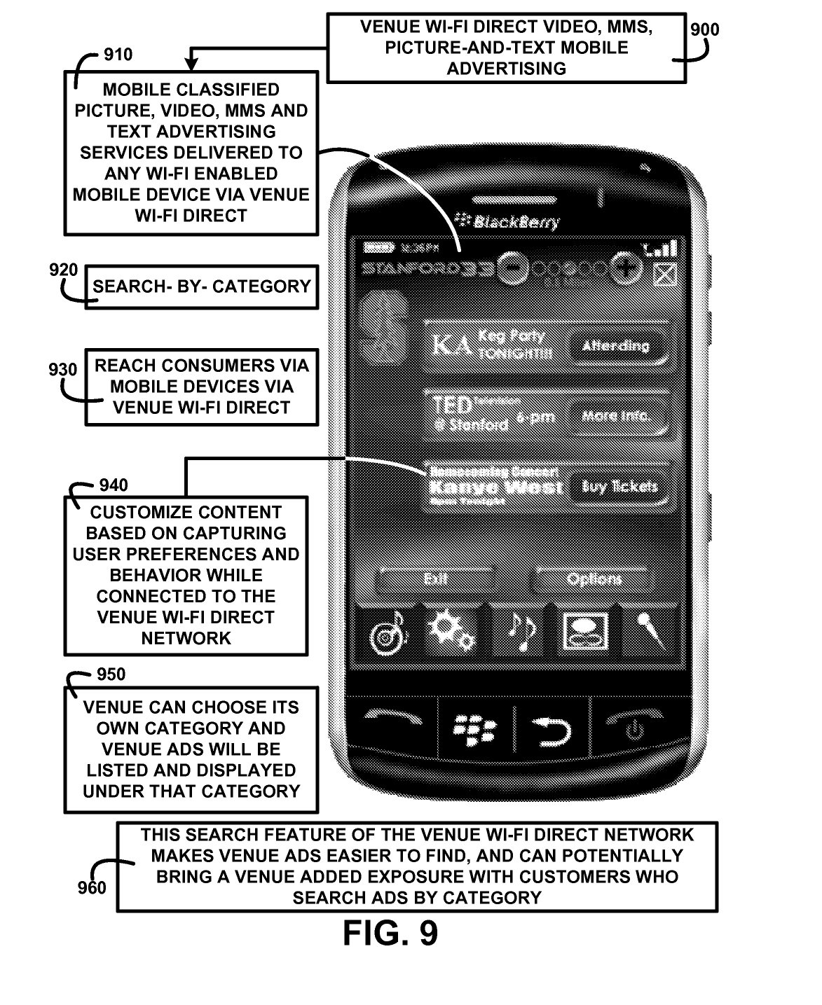

FIG. 9 shows for illustrative purposes only an example of venue WI-FI direct video, mms, picture-and-text mobile advertising of one embodiment of the present invention. FIG. 9 shows venue WI-FI direct video, mms, picture-and-text mobile advertising 900 that includes mobile classified picture, video, mms and text advertising services delivered to any WI-FI enabled mobile device via venue WI-FI direct 910. A search-by-category 920 element can reach consumers via mobile devices via venue WI-FI direct 930. The venue can customize content based on capturing user preferences and behavior while connected to the venue WI-FI direct network 940. Each venue can choose its own category and venue ads will be listed and displayed under that category 950. This search feature of the venue WI-FI direct network makes venue ads easier to find, and can potentially bring a venue added exposure with customers who search ads by category 960 of one embodiment.

### Video, MMS, Picture-and-Text Mobile Advertising

Reach consumers via mobile devices via WI-FI with the ability to customize content based on capturing user preferences and behavior while connected to the network.

### Search-by-Category

You can choose your own category and your ad will be listed and displayed under that category. This search feature of our WI-FI network makes your ad easier to find, and can potentially bring you added exposure with customers who search ads by category. Customers seeking German Beer, non-pork hot dogs can search and receive information on available items in the venue. Individuals seeking to purchase tickets for sold out events can connect with users outside of venues to make purchases. Mobile Classified Picture, Video, MMS and Text advertising services delivered to any WI-FI enabled mobile device via Wi-Fi. Advantages while consumers are connected to Wi-Fi network are “always-on” advertising service platform delivering continuous connectivity and exposure to your customers when they're on the go.

Mobile Purchases
Place order from menu or send alerts to receive services at the location each mobile device user is located
Pay Via Credit Card or PayPal or other mobile enabled payment platform on the mobile device through the WIFI network
Ability to store mobile device user preferences on the network including seating preference, food preferences, merchandise preferences for repeat ordering

Click-to-Order and More . . .

Every ad includes mobile device features such as Click-To-Order, Click-To-Call, Text-to-Order or Click-For-Help via WI-FI network. Mobile device users empower parents and guardians to track their children with the aid of our real-time tracking utility. The parent is able to define a set distance that they are comfortable with. If the child steps outside of the comfort zone, the parent is immediately notified with an alert and they are able to track and find them.

Mobile Coupons

Mobile Coupons Generated based search results
When the alert/link is clicked it goes to the store/retail outlet
1. Consumer is searching on the mobile device
2. Consumer is specifying they are seeking what the advertiser is offering
3. Consumer is looking for items in the WIFI covered network
4. Implementation of a mobile device driven digital rewards card system
5. The mobile device users are allowed to send notifications/announcements to other users over WI FI.
6. Customize announcements broadcast it to the desired users or groups of users.
7. Mobile announcements can be sent instantaneously reach a larger audience quicker.
   Secure Cloud Payments; allow mobile device empowered to live life without having to constantly pull out plastic or cash securely.

Mobile Notifications

### Notification System

Mobile device users at colleges, corporations, government institutions, stadiums, arenas, convention centers can receive notifications. These messages can be configured to be sent to users in specific categories or that are a member of specific groups.
This enables utilities to be utilized as tools to keep all individuals in covered area aware of possible issues.
Receive Instant-seating information and information on how long lines are for restrooms, concession stands and ticketing locations.

### Types of Messages/Communications

What messages can you send via Wi-FI
Sales Announcements
Promotional Offers
Discount Coupons
Menu Specials
Seating Upgrades
Sponsored Content
General Business Info
Specials of the Day
Schedules
Special Events Calendar

Tailgate

Ability to send WIFI signals externally to reach tailgaters at events to deliver information on location of:
Parking availability with maps and direction and cost
Trash cans
Restrooms
Retail Outlets
Food Vendors

Security

Ability to monitor via WIFI internal and external activities using sensors connected to the network delivering information to the control system. The ability to detect and alert teams of the following for example:
Explosives
Weapons
Chemicals
Gas
Drugs
   Ability to integrate video surveillance system over WIFI to deliver feeds to control rooms

Fantasy Sports
Gain revenue opportunities with licensed products
Interactive alerts
Live Interaction between players Social Networking Component
Real-time updates and stats on players
Real-time marketing
Merchandise sales
Subscription plans
Mobile device users Mobile Fantasy
Licensed Gain of Revenue
Interactive Real-Time Alerts
Real-Time Interaction Between Players

Mobile Advertising

Mobile devices when combined with user profiles and meta-tags and proximity awareness allows intelligent search and alert capabilities.
Intelligent Advertising
Ability to filter advertising to display only relevant ads
Ability to pull ads based on specific wants
Ability to save or forward ads
Ability to pull coupons for relevant products/services
Personalize applications running in the covered area
Track mobile device user behavior to continuously update preferences and deliver highly targeted audiences to advertisers
Mobile users are able to search for a restaurant, specific food items, specialty souvenirs, in the covered area
Mobile users are allowed to set the search radius to determine the distance for the search results
For example if a mobile user is looking for a nearby restroom within a 500 foot radius they can set the search range for 500 feet.
   Advertisers and sponsors are empowered to connect specifically to individuals seeking information on their products and services. Advertisers send advertisements that are filtered to only deliver relevant content to mobile device users based on preferences and real-time analytical data collected. Advertising content can be specified based on the location of the user and related information displayed based on the users proximity to specified search or profile. Search results are generated based on the meta tags mobile device users specify as well as historical data collected by behavior.
   Ability to drag down (pull down content) to select relevant advertising that the user in interested in. Advertisers send advertisements that are filtered to only deliver relevant content to mobile device users based on preferences and real-time analytical data collected. Advertising content can be specified based on the location of the user and related information displayed based on the users proximity to specified search or profile Search results are generated based on the meta tags mobile device users specify as well as historical data collected by behavior. Ability to drag down (pull down content) to select relevant advertising that the user in interested in.

### Advertising (In Wifi Areas Purchases)

Deliver to mobile device users basic business info: locations
Send mobile coupon that offers attractive discounts
Announce current and future sales promotions
Publish a “Featured Product of the Day” and offer a special price

### Advertisements for Local Bars and Restaurants . . .

Send daily specials—lunch, happy hour, and early bird specials
Bars/Night Clubs can send schedule of featured entertainers.
Send promotional offers—2-for-1, free stuff, etc. Generate traffic.

### Professionals, Artists, Bands . . .

Announce info about your services, products, price list, etc.
Real estate agents can broadcast a “new listings” alert.
Bands can send “gig” alerts and reminders to their fan base.
Artists can publish upcoming shows and gallery events.
Professional speakers can provide info about featured events.

### Recruiters and HR Professionals

Provide information on upcoming job openings
Deliver customized messages based on skill set “keyword” preferences
Send requests for response including resume requests

### Skip Ads/Real-Time Preference Updates

WI-FI users can instantly opt in or out to receive specific content and or information with the ability to change/update/modify ad preferences at will. Categories can be customized for unlimited options for delivery of information.

### HDWIFI Technologies:

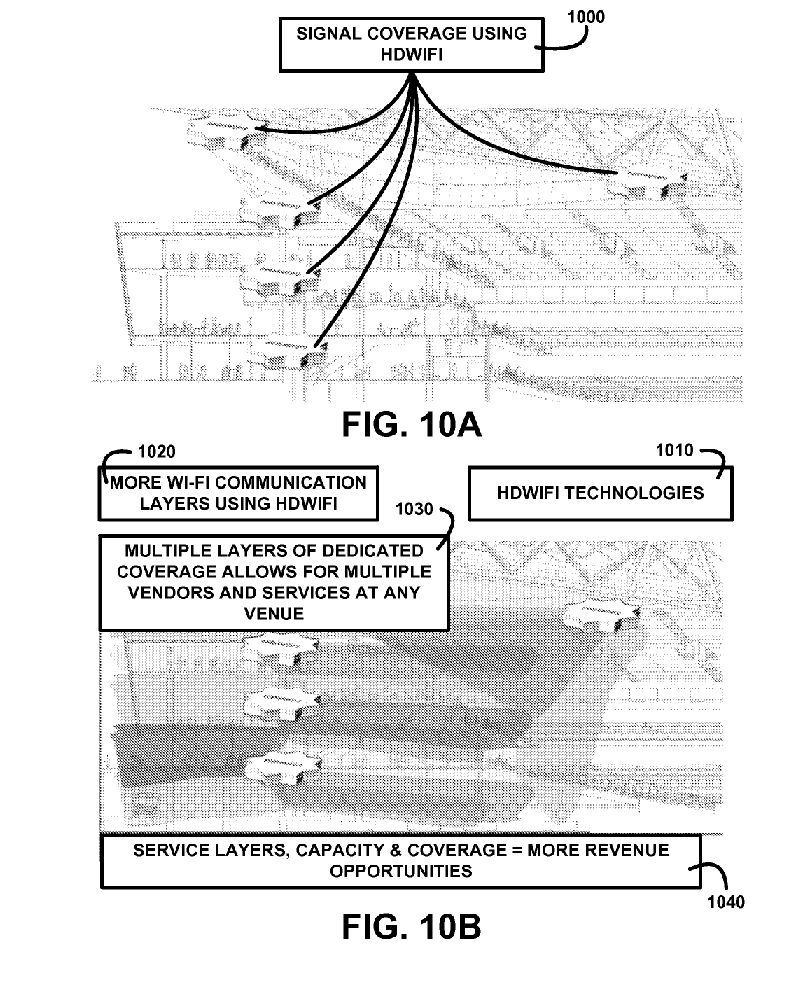

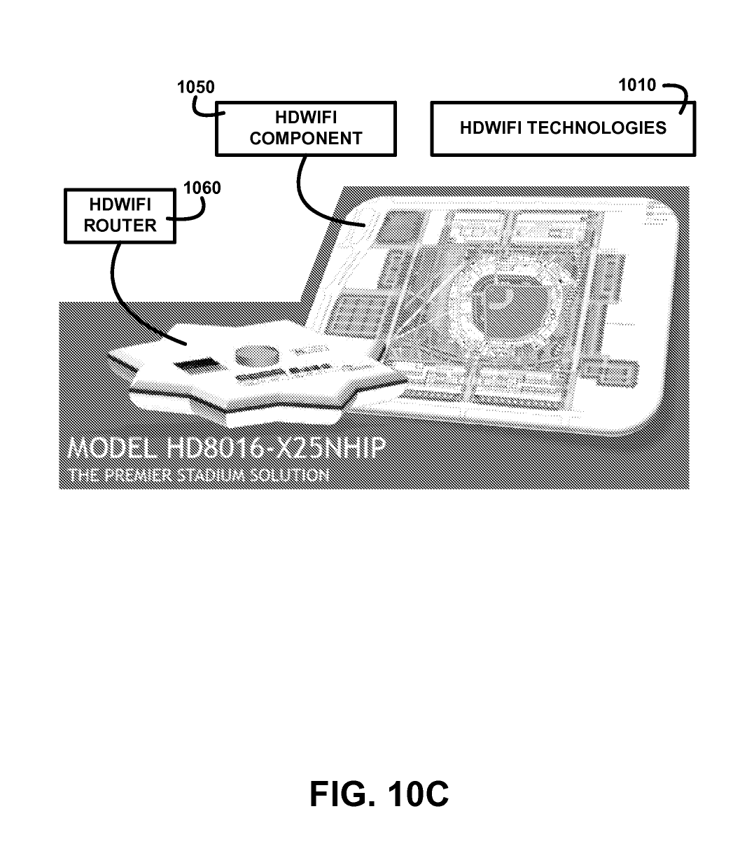

FIG. 10A shows for illustrative purposes only an example of signal coverage using HDWIFI of one embodiment of the present invention. FIG. 10A shows signal coverage using HDWIFI 1000 in an example of a stadium venue of one embodiment.

FIG. 10B shows for illustrative purposes only an example of WI-FI communication layers using HDWIFI of one embodiment of the present invention. FIG. 10B shows HDWIFI technologies 1010 deployed in a stadium venue and more Wi-Fi communication layers using HDWIFI 1020 being provided to the venue covered area. HDWIFI technologies 1010 provide multiple layers of dedicated coverage allows for multiple vendors and services at any venue 1030. The capacity to provide multiple layers of dedicated coverage results in more service layers, capacity & coverage=more revenue opportunities 1040 of one embodiment

FIG. 10C shows for illustrative purposes only an example of a HDWIFI router of one embodiment of the present invention. FIG. 10C shows example of equipment used for HDWIFI technologies 1010. The HDWIFI technologies 1010 equipment includes a HDWIFI component 1050 used to display broadcast content for a venue and a HDWIFI router 1060 used to provide a Wi-Fi communications layer of one embodiment.

### HD8000 Series Component:

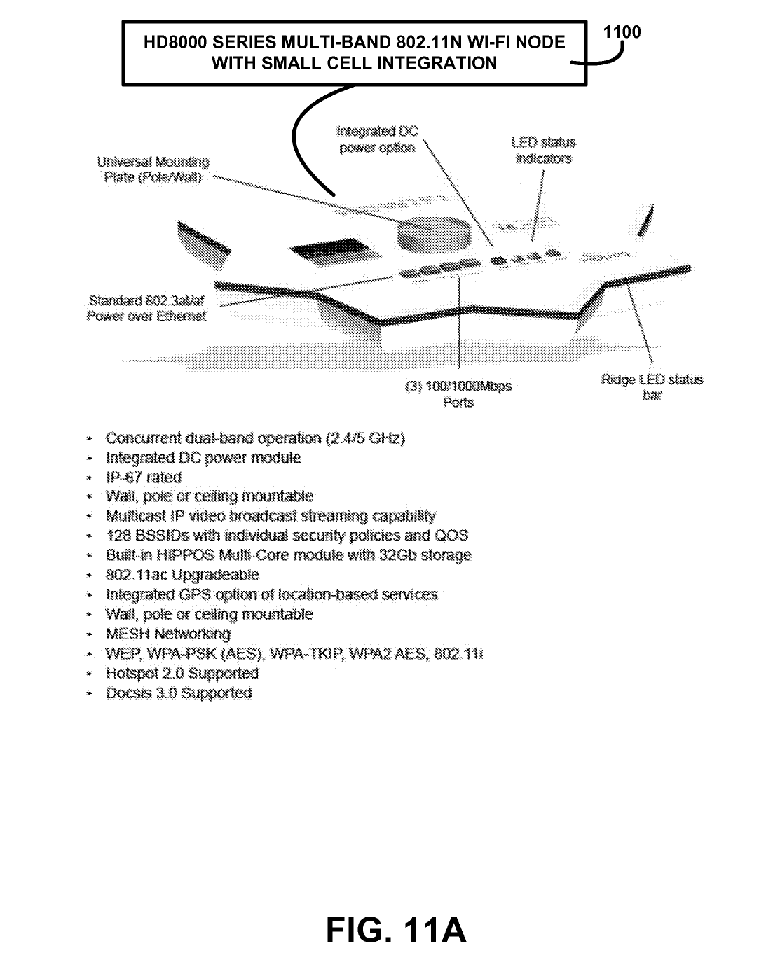

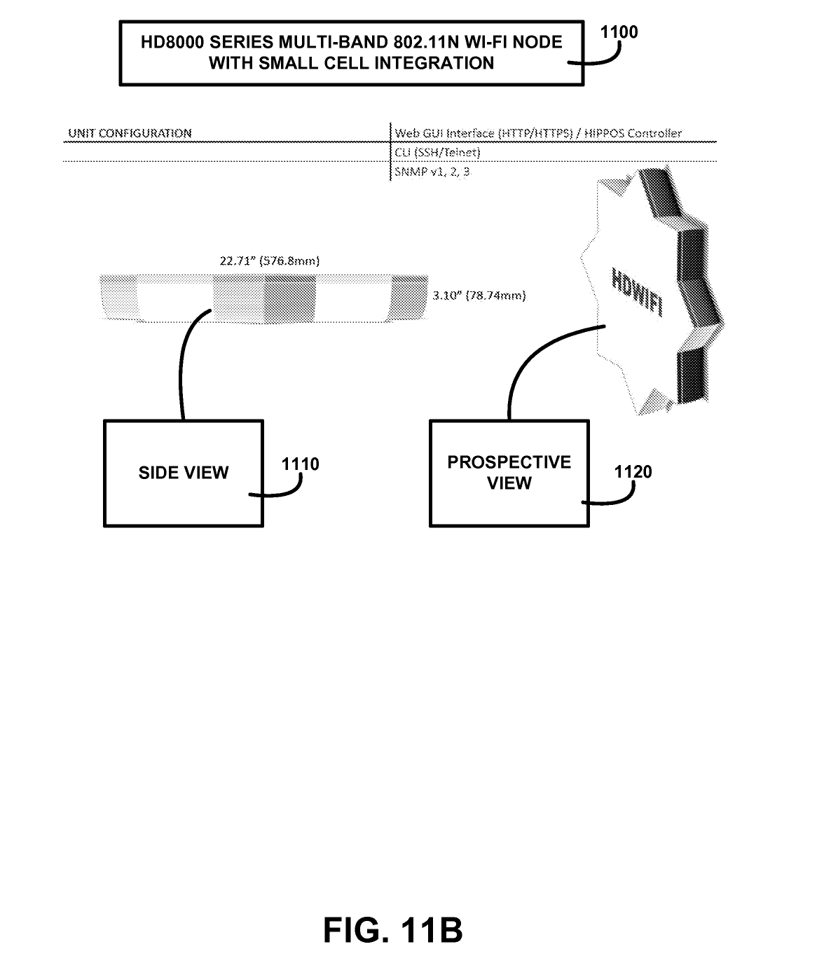

FIG. 11A shows for illustrative purposes only an example of a HD8000 Series component of one embodiment of the present invention. FIG. 11A shows an example of a HD8000 Series Multi-band 802.11n Wi-Fi node with small cell integration 1100.

FIG. 11B shows for illustrative purposes only an example of a HD8000 Series component of one embodiment of the present invention. FIG. 11B shows an example of a HD8000 Series Multi-band 802.11n Wi-Fi node with small cell integration 1100. FIG. 11B shows an example of a HD8000 Series in a side view 1110 and a prospective view 1120. HD8000 Series Multi-band 802.11n Wi-Fi node with small cell integration 1100 physical information.

PHYSICAL INFORMATION

| | |
|---|---|
| POWER | Power over Ethernet Pass Through |
| | 12 VDC/24 VDC |
| | Power over Ethernet 802.3af/24 VDC |
| PHYSICAL SIZE | 22.71″ (w) × 3.10″ (h) |
| | 459.74 mm × 78.74 mm |
| WEIGHT | 3.5 lbs (1587 grams) to 8.5 lbs (2767 MS) |
| | Dependant on Configuration Selected |
| BUILT-IN | Internal configurable pattern |
| ANTENNAS | 2 to 11 GHz UltraWide band |
| ETHERNET | 4 × 10/100/1000 Mbps, auto MUX, auto-sensing |
| PORTS | RJ45 HD8008-X25NHIP & HD8016-X25NHIP |
| | 2 × 10/100/1000 Mbps, auto MUX, auto-sending |
| | RJ45 HD8008-X25NBASIC |
| HD8016X25AC | 1 × 10 Gbase*** |
| Model Only | |
| ENVIRONMENTAL | Operating temperature: −40 deg C. to 65 deg C. |
| | IP-67 rated enclosure |
| | 60 to 140 W (24 VDC)/HD8016, HD8008 |

CONFIGURATION SPECIFICATIONS
(All Hippos Powered Units have HIP designation in Model Number)

| | | |
|---|---|---|
| WIRELESS STANDARDS | IEEE 802.11 a/b/g/n | 2.4 GHz and 5 GHz concurrent |
| | | operation |
| PER RADIO DATA RATES | 802.11n: 6.5 Mbps-144 Mbps | 802.11a: 6 Mbps-54 Mbps (20 MHz) |
| 1 × 1:1 Radio Chains | (20 MHz) | 802.11g: 6 Mbps-54 Mbps (20 MHz) |
| 2 × 2:2 Radio Chains | 802.11n: 6.5 Mbps-300 Mbps | 802.11n: 13.5 Mbps-450 Mbps |
| 3 × 3:3 Radio Chains | (40MHz) | (40 MHz) |
| MAX DEVICE THROUGHPUT | 1200 Mbps | Model HD8008-X25NBASC |
| | 1200 Mbps | Model HD8008-X25NHIP |
| | 1800 Mbps | Model HD8008-X25ANHIP |
| | 2400 Mbps | Model HD8016-X25NBASIC |
| | 2400 Mbps | Model HD8016-X25NHIP |
| | 3600 Mbps | Model HD8016-X25ANHIP |
| CLIENT STATIONS** | 960/400 | Model HD8008-X25NBASIC |
| | 1200/560 | Model HD8008-X25NHIP |
| | 2400/1120 | Model HD8016-X25NBASIC |
| | 2400/1120 | Model HD8016-X25NHIP |
| OPERATING FREQUENCY | 2.4-2.484 GHz | 320 mw ~ 600mw |
| BANDS & POWER OUTPUT | 4.9-6.100 GHz | 320 mw ~ 600mw |
| | 4.95 GHz-6.10 GHz | |
| | SUMMIT WHITE/PAINTABLE | |

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method, comprising:
providing venue specific localized WI-FI user mobile venue related services in a covered venue area;
installing in a densely populated covered venue area technology capabilities capable of handling a number of users in real time and a number of services in real-time; and
using localized WI-FI user mobile applications to provide venue related services.

2. The method of claim 1, further comprising at least one user mobile device application including at least interactive video, Multimedia Messaging Service (MMS), picture-and-text mobile advertising, merchandizing, mobile orders, user scanned purchases, fantasy sports, people tracking, mobile alerts, and PECOS/Hyper Imbedded Parallel Processing Operating System (HIPPOS) software.

3. The method of claim 1, further comprising user scanned purchase application including a scan of a QR Code of a user event seat which displays a menu of all available vendors and food selections in an event arena.

4. The method of claim 1, further comprising in a cashless mobile device payment application system wherein a user may pay for purchases of orders at an event.

5. The method of claim 1, further comprising mobile alerts wherein authorities including campus police may keep students alert to on campus emergencies and Federal and State emergency agencies may release alerts to users about natural disasters and evacuation routes.

6. The method of claim 1, further comprising fully integrating a control software platform for providing venue related services through localized WI-FI user mobile applications in sub-second real-time interoperability among the many different, incompatible, “equipment systems” in large complex environments.

7. The method of claim 1, further comprising a venue WI-FI direct people tracking application wherein the people tracking application may be used to locate people in a user group attending a densely populated venue including a theme park.

8. The method of claim 1, further comprising customization of venue specific localized WI-FI services using PECOS/hyper imbedded parallel processing operating system (HIPPOS) to assemble vendor-independent integrated control-operating platforms.

9. The method of claim 1, further comprising multiple layers of dedicated coverage allows for multiple vendors and services at any venue including sporting events at arenas, ballparks and stadiums, theme parks, large stores, malls, shopping centers, concerts at large arenas and amphitheaters, convention centers and public tourist attractions and parks.

10. The method of claim 1, Further comprising venue WI-FI direct video, mms, picture-and-text mobile advertising including mobile classified picture, video, mms and text advertising services delivered to any WI-FI enabled mobile device via venue WI-FI direct, wherein the services use venue WI-FI direct customized content based on capturing user preferences and behavior while connected to the venue WI-FI direct network 940.

11. An apparatus, comprising:
at least one user mobile device application configured to provide venue related services in sub-second real-time interoperability among the many different, incompatible, equipment systems in large complex environments;
a venue WI-FI direct customized content based on capturing user preferences and behavior configured to allow at least one user mobile device application to provide venue specific localized WI-FI services;
a densely populated covered venue area technology capabilities capable of handling a number of users in real time and a number of venue specific localized WI-FI services in real-time.

12. The apparatus of claim 11, further comprising the densely populated covered venue area technology capabilities configured to include using hyper imbedded parallel processing operating system (HIPPOS) to assemble vendor-independent integrated control-operating platforms.

13. The apparatus of claim 11, further comprising at least one user mobile device application including at least interactive video, mms, picture-and-text mobile advertising, merchandizing, mobile orders, user scanned purchases, fantasy sports, people tracking and mobile alerts.

14. The apparatus of claim 11, wherein at least one user mobile device application is configured to function on multiple layers of dedicated coverage for multiple vendors and services at any venue including sporting events at arenas, ballparks and stadiums, theme parks, large stores, malls, shopping centers, concerts at large arenas and amphitheaters, convention centers and public tourist attractions and parks.

15. The apparatus of claim 11, wherein real-time interoperability is configured to include a PECOS/Hyper Imbedded Parallel Processing Operating System (HIPPOS) software control software platform to provide comprehensive, real-time, systems integration for any and all equipment devices simultaneously.

16. An apparatus, comprising:
a software control software platform to provide comprehensive, real-time, systems integration for any and all equipment devices simultaneously;
multiple layers of dedicated coverage for multiple vendors and real-time services using localized WI-FI user mobile device applications; and
at least one user mobile device application including at least interactive video, multimedia messaging service, picture-and-text mobile advertising, merchandizing, mobile orders, user scanned purchases, fantasy sports, people tracking and mobile alerts.

17. The apparatus of claim 16, wherein the software control software platform is configured to include PECOS/Hyper Imbedded Parallel Processing Operating System (HIPPOS) software to provide comprehensive, real-time, systems integration for interoperability among the many different, incompatible equipment systems in large complex environments.

18. The apparatus of claim 16, wherein the multiple layers of dedicated coverage is configured to include at least one High Density (HD) WIFI router to provide a Wi-Fi communications layer, and at least one HDWIFI component to display broadcast content for a venue.

19. The apparatus of claim 16, wherein
at least one user mobile device application is configured to include a user scanned purchase application including a scan of a QR Code of a user event seat which displays a menu of all available vendors and food selections in an event arena for placing user mobile orders and facilitating user scanned purchases.

20. The apparatus of claim 16, wherein real-time services is configured for people tracking wherein a people tracking application may be used to locate people in a user group attending a densely populated venue including a theme park and is configured to include mobile alerts wherein authorities may transmit WIFI alerts to users including to alert students to on campus emergencies, users about natural disasters and evacuation routes, Amber Alerts, safety issues, traffic jams, special announcements, event calendars, sales invitations, promo offers, product intros, and discount deals to devices on a venue WI-FI network.
